(19) United States
(12) Patent Application Publication
(10) Pub. No.: US 2008/0215910 A1
(43) Pub. Date: Sep. 4, 2008

(54) High-Availability Networking with Intelligent Failover

(75) Inventors: Cynthia Gabriel, Gilroy, CA (US); Dar-ren Leu, San Jose, CA (US); Vijoy Pandey, San Jose, MA (US); Tien-Wei Chao, San Jose, CA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: NORTEL NETWORKS LIMITED, St. Laurent, QC (CA)

(21) Appl. No.: 11/995,965

(22) PCT Filed: Aug. 16, 2006
(86) PCT No.: PCT/US06/31937

§ 371 Date: Jan. 17, 2008

Related U.S. Application Data
(60) Provisional application No. 60/708,863, filed on Aug. 17, 2005.

(51) Int. Cl. G06F 11/20

(52) U.S. Cl. 714/4; 714/E11.071

(57) ABSTRACT

Methods and systems for maintaining high-availability in a computer network using intelligent failover are presented. In a network switch running an OSI model layer-2 or higher protocol on its external links, the protocol state information is monitored to determine failover status of the link to avoid identifying external link failures due to link flapping. One such protocol is the spanning tree protocol. Additionally, flexibility in failover is provided using configurable triggers to define external failure events. The triggers initiate a link drop of one or more internal links of the network switch in response to an external failure event. The link drops, in turn, initiate failover of an attached computing device to a redundant link through a network interface teaming/failover arrangement whereby the computing device switches to an alternative network interface accessing the network through a redundant path. Failover can be selective depending upon VLAN and trunking configurations.

### RELATED APPLICATION

This application claims the benefit of U.S. Provisional Application No. 60/708,863, filed Aug. 17, 2005. The entire teachings of the above application are incorporated herein by reference.

### FIELD OF THE INVENTION

This invention relates generally to the field of computer networks. More particularly, this invention relates to maintaining high availability in a computer network utilizing link redundancy and failover control.

### BACKGROUND OF THE INVENTION

Computer networks play an ever expanding role in today's economy. As the available number and types of networked resources increase, combined with increases in speed and affordability of communications bandwidth, networks are becoming in some sense indistinguishable from computing systems. One example of such a reliance on computer networking occurs at the enterprise level as demonstrated by networked storage solutions. Rather than providing physical storage at a client system, the enterprise relies on shared storage whereby high-density, network-accessible storage servers are separately managed from client systems. Such a growing reliance on networks to perform even basic computing services, such as storage, imposes increasing demands for high availability. Any network interruptions can range from a mere inconvenience to an intolerable situation for mission critical applications.

In some cases, mechanisms may be put into place to detect an error in a network connection and to notify a network administrator. The administrator may then take action to identify the source or at least the general location of the error and to take corrective action, such as reconfiguring network resources. Unfortunately, such actions take time and result in interruptions to workflow. Such a manual intensive approach would be hard pressed to meet the high availability requirement of today's mission critical systems.

In other cases, resources are provided to facilitate a failover to a redundant resource. One such example is illustrated in FIG. 1. A high-availability networked computer system 100 includes one or more servers 102a, 102b, 102c (generally 102), each including multiple network interfaces 104a, 104b, 104c, 104d (generally 104), each interface 104 coupled to a different network switch 106a, 106b, 106c, 106d (generally 106). The servers 102 can represent blade server modules of a blade server system. The multiple network interfaces 104 of each server 102 are controlled by a teaming/failover controller that monitors the internal link status at the physical layer. Upon detecting a link drop, the teaming/failover controller fails over to one of the other network interfaces 104, thereby reestablishing communications over a different internal link and through a different switch 106.

Some systems provide a mechanism to monitor external link state through the physical layer of the external ports (EXTA-EXTD). In response to detecting an external link failure, the mechanism also triggers an internal link drop on all of the corresponding internal ports (INTA-INTD) of the associated switch 106. This link drop initiates the failover mechanism provided on each of the servers 102 with an active link to the effected switch 106 so that it could properly failover, switching its active link to another one of the network interfaces.

Unfortunately, monitoring external link states at the physical layer of an external switch port is susceptible to frequent “link flapping” issues experienced when enabling that port. Only having physical-layer status, the system is unable to distinguish between “real” link failures and the intermittent link flapping events. Consequently, this leads to unnecessary internal link drops and failover events at the respective server 102 causing it to ping-pong between selecting the appropriate active link.

### SUMMARY OF THE INVENTION

What are needed are methods and systems to provide high availability network connectivity in a computer system. The present invention satisfies these needs and provides additional advantages. In particular, the present invention provides processes and systems for monitoring external link state using state information obtained from an OSI model layer 2 or higher protocol running on the external link. Relying on information from such a protocol as the spanning tree protocol (STP), it is possible to avoid falsely identifying external link failures due to link flapping. In addition, the present invention provides processes and systems providing flexibility in the definition of an external failure event by providing configurable triggers. Only when the trigger event occurs, is an internal link drop initiated causing failover to a redundant link. Thus, a STP state can be monitored on at least one identified Virtual Local Area Network (VLAN). Further, the STP state can be monitored for static trunk groups or LACP (Link Aggregation Control Protocol (LACP) trunk groups.

In one aspect, the invention features a process for maintaining network connectivity in a computing device coupled to a network through at least one spanning-tree-protocol enabled switch. The computing device includes multiple network interfaces adapted in a failover configuration. One of the network interfaces is active and in communication with an internal switch port, such that the active network interface is in switchable communication with a remote network through the switch. External links from the switch to the remote network can use one or more external switch ports, depending upon a trunking configuration. The STP state of the one or more external switch ports is monitored. An external failure event is determined based on the monitored STP states of the one or more external switch ports. Upon determining an external failure event, one or more internal links coupled between the active network interface and the internal switch port are deactivated, or “dropped” in response to the identified external failure event. A failover from the active network interface to another one of the multiple network interfaces is initiated in response to the deactivated internal link.

In another aspect, the invention features a network-enabled computer system for maintaining high availability network connectivity between the computer system and a network. The computer system includes a computing device having multiple network interfaces adapted in a failover configuration. Each network interface is coupled to one side of a respective internal communication link with one of the network interfaces being active. A spanning-tree-protocol enabled switch has an internal port coupled to another side of the respective internal communication link. The active network interface is in switchable communication with at least one external port of the switch coupled to the network through an external communication link. An intelligent failover controller includes a fault monitor in communication with the STP enabled switch for monitoring a STP state at the at least one external port. The intelligent failover controller also includes a link-drop controller in communication with the fault monitor. The link-drop controller selectively initiates a link drop on one or more of the internal communication links in response to the monitored STP state. The active network interface fails over to another one of the multiple network interfaces in response to the link drop.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 illustrates a block diagram of an exemplary embodiment of a high-availability, fault-tolerant communications network.

FIG. 2 illustrates a block diagram of one embodiment of a high-availability, fault-tolerant communications network.

FIG. 3A illustrates a flow diagram of one embodiment of an external link monitor and failover control process.

FIG. 3B illustrates a flow diagram of one embodiment of a teaming/failover monitor and control process.

FIG. 4 illustrates a more detailed block diagram of one embodiment of an intelligent failover controller.

FIG. 5 illustrates a block diagram of one embodiment of a blade server system.

FIG. 6 illustrates a more detailed block diagram of an exemplary blade server module shown in FIG. 5 including a failover capability.

FIG. 7 illustrates a schematic block diagram of one embodiment of interconnections between the blade server modules and switches of FIG. 5.

FIG. 8 illustrates a more detailed block diagram of one embodiment of a switch module shown in FIG. 5 and FIG. 7 including an external link monitor and failover control capability.

FIG. 9 illustrates a block diagram of another exemplary embodiment of a high-availability, fault-tolerant communications network.

FIG. 10 illustrates a schematic representation of a configuration menu structure used to configure the high-availability, fault-tolerant communications network.

### DETAILED DESCRIPTION

A description of preferred embodiments of the invention follows.

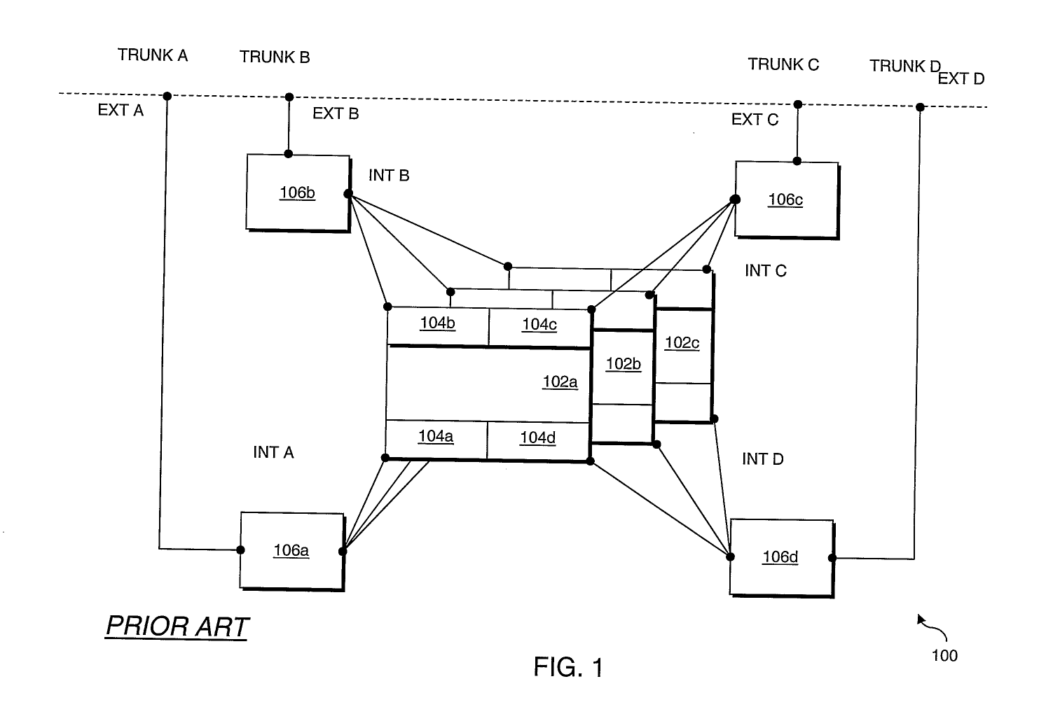

In computer network architectures, a network-enabled computing device is often coupled to a network through one or more network switches. As described above in relation to FIG. 1, the computing device can be provided with multiple network interfaces configured in a teaming/failover arrangement to provide high availability network connectivity. Upon detection of a link drop on one of the active internal communication links, a network-interface teaming controller, often provided within the computing device, transfers network access to one of the other network interfaces of the same computing device. Thus, network connectivity is maintained by switching to another network interface coupled to a different internal communication link. Preferably, each of the different network interfaces is coupled to a network switch through a different internal communication link. More preferably, each of the different internal communication links is connected to a different respective network switch, accessing the remote network through different external links. Such a configuration leads to fully-redundant paths from each server to the remote network.

Even with the above configuration, there can be inefficiencies such as those due to unnecessary failover from link flapping. By providing an intelligent failover controller, a more reliable network interface failover can be achieved thereby avoiding unnecessary failover actions. In more detail, the intelligent failover controller includes a monitor adapted to monitor status of the external communication links using information obtained from a networking layer above the physical layer. The monitored information can be obtained from an OSI model layer-2 or higher protocol. For example, the monitored information can be obtained from at least one of the spanning tree protocol (STP) described in IEEE Standard 802.1D and the rapid spanning tree protocol described in IEEE 802.1D-2004. In particular, the intelligent failover controller monitors the external links to identify which links, if any, are not in an operational state as determined by the layer-2 or higher protocol state.

For the STP example, the external port is always in one of the following states: Forwarding; Listening; Learning; Blocking; and No Link. For STP, any monitored state other than the Forwarding state can be considered to be non-operational. The STP state information can be obtained from STP state machine that are typically provided for each of the external ports of an STP-enabled switch. Thus, the intelligent failover monitor examines the current STP state of each of the state machines to determine whether the associated external link is in a forwarding state.

Upon one or more of the monitored external links being in a non-operational STP state, the intelligent failover controller can selectively initiate a link drop causing a corresponding link drop on one or more of the internal communication links. Teaming/failover controllers on the computing devices connected to the dropped internal link will operate as described herein, failing over to another one of the network interfaces, thereby accessing another network switch through a different internal communication link to maintain network communications. Beneficially, the intelligent failover controller provides additional features to allow definition of one or more failure events, each described at least in party by the particular failed external switch ports, and to allow the definition of appropriate control ports through which an internal link drop is initiated upon detection of the related external failure event.

Additional advantages are gained in providing high-availability to bandwidth sensitive applications, such as multimedia servers and voice over IP (VoIP) solutions. Such applications are sensitive to bandwidth fluctuations due to failed links within a trunk. By providing an ability to detect the number of operational links within a trunk and to define external failure events based on a threshold number of active links for the trunk, it becomes possible to preserve traffic quality.

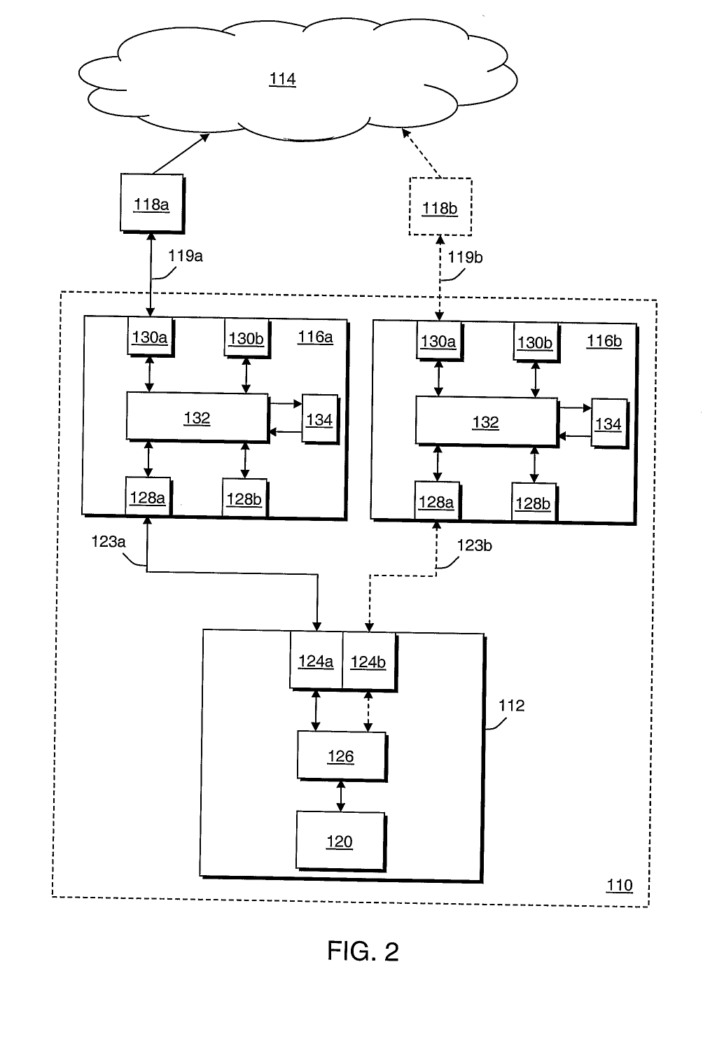

FIG. 2 illustrates a block diagram of an exemplary high-availability, network-enabled computer system 110 including an intelligent failover controller. The computer system 110 includes at least one computing device 112 and two network switches 116a, 116b (generally 116). The computing device 112, in turn, includes a processor 120 and two network interfaces 124a, 124b (generally 124). Each of the network interfaces 124 is uniquely coupled to one of the network switches 116 through a different internal communication link 123a, 123b (generally 123). Each of the network switches 116, in turn, is coupled to the same remote network 114 through a different external communication link 119a, 119b (generally 119). Thus, fully redundant paths are provided between the computing device 112 and the remote network 114, which can be a local area network, a metro area network, or a wide area network, such as the Internet. In some embodiments, each of the network switches 116 is coupled to the network 114 through a respective down-stream network device, such as the down stream network switches 118a, 118b (generally 118) shown.

The computing device 112 also includes a network-interface teaming/failover controller 126 in communicates with each of the two network interfaces 124. The teaming/failover controller 126 manages the two network interfaces 124 in a redundant, failover configuration. Thus, at any given time one of the two network interfaces 124 is active, forwarding and receiving network traffic between the computing device 112 and its interconnected network switch 116. The other network interface 124 remains in standby, ready to assume the active role should that become necessary. Each of the redundant network interfaces shares the same network address to avoid interruption of network traffic in the event of a failover.

The network interface 124 allows the computing device 112 communicate over a computer network by including electronic circuitry required to communicate according to a specific physical layer and data link layer standard such as Ethernet or token ring. This provides a base for a full network protocol stack, allowing communication among small groups of computers on the same LAN and large-scale network communications through routable protocols, such as IP. The network interface is an OSI model layer-2 item because it has a media access control (MAC) address. In some embodiments, the network interfaces 124 can be individual removable network interface cards (NIC). In other embodiments, the network interfaces 124 can be integral to the computing device 112.

The teaming/failover controller 126 monitors status of the internal communication link 123a. This can be accomplished at the active network interface 124a by monitoring link status of the physical link layer. Upon detecting an interruption, or link drop, the teaming/failover controller 126 places the active network interface 124a a non-active state, and transitions one of the other network interfaces 124b from standby into an active state.

An internal link drop may result from a failure of any of the active network interface 124a, the internal communication link 123a, the network switch 116a, and any upstream links 119a and devices 118a. Upon the teaming/failover controller 126 detecting a link drop of the first internal link 123a, the teaming/failover controller 126 initiates a failover to the second network interface 124b. Having an independent physical path to the network 114, the second network interface 124b takes over network communications continue between the computing device 112 and the network 114 using the same network address.

Without receiving any more than an internal link drop, the teaming/failover controller 126 is generally unaware of the location and nature of the failure. Thus, a robust design provides for complete redundancy in all components from the network interface 124b to the network 114, as shown. The source of the link drop can be determined by alternate means such as automatic or manual failure diagnostics and later corrected.

Each switch 116 includes multiple server-side, or internal switch ports 128a, 128b (generally 128) for connecting to the computing device 112 and referred to herein as internal ports 128. Each switch 116 also includes multiple network-side, or external switch ports 130a, 130b (generally 130) for connecting to the network, referred to herein as external ports 130. The switch 116 also includes a switching module 132 in communication with all of the internal and external ports 128, 130 for controlling and establishing interconnections between one or more of the ports 128, 130. An intelligent failover controller 134 is provided in communication with the switching module 132.

The switching module 132 implements an OSI layer 2 or higher protocol for each of the ports. The intelligent failover controller 134 monitors protocol-related information, such as an associated state of related external port 130 to determine whether the interconnected link is operational. Upon determining that one or more of the monitored ports 130 are not operational, the intelligent failover controller 134 initiates a link drop at one or more definable control ports, such as one or more of the internal ports 128.

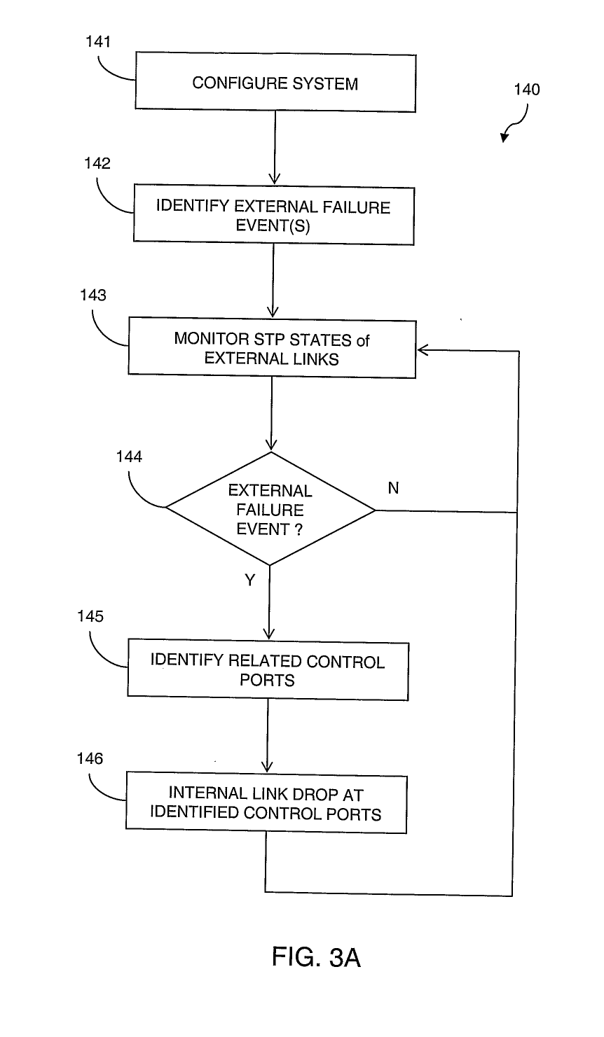

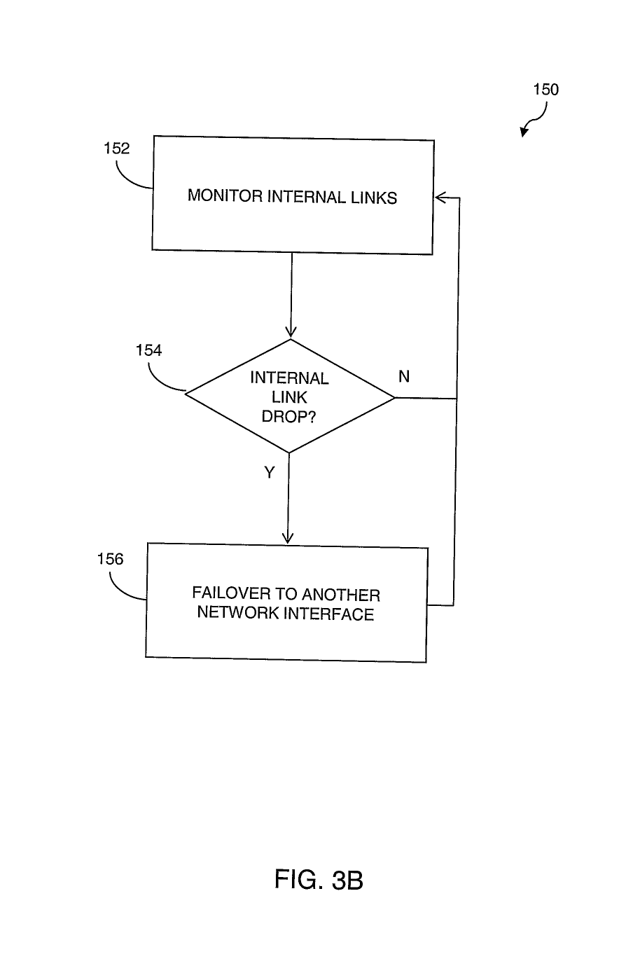

In brief overview, FIG. 3A illustrates a flow diagram of one embodiment of an external link monitor and failover control process 140. As part of a system initialization, the system is configured at Step 141. The configuration can include configuring the network switch 116 (FIG. 2) as would routinely be accomplished by a network administrator. In some embodiments, the configuration also includes identifying one or more of the switch ports 128, 130 (FIG. 2) as belonging to one or more VLANs.

Alternatively or in addition, configuration includes the establishment of one or more trunks. A trunk refers to using multiple physical network cables or ports 130 arranged in parallel as a single logical port to increase the link bandwidth beyond the limits of any one single cable or port. The trunks can be created using static trunk groups in which two or more external ports are identified as belonging to the same static trunk. Alternatively, trunks can be established using the link aggregation control protocol (LACP) as described in IEEE specification 802.3ad. This allows for bundling several physical ports 130 together to form a single logical channel, whereby the network switch 116 negotiates an automatic bundle by sending LACP packets to a peer (e.g., the downstream switch 118 (FIG. 2)). Benefits of trunking include higher bandwidth connections, load sharing, and fault tolerance protection.

As a second phase of the configuration process at Step 142, an administrator configures one or more triggers on the network switch 116, whereby each trigger defines an external failure event. The ability to define external failure events provides additional intelligence and flexibility in determining when the intelligent failover controller 134 on the network switch 116 will initiate a link drop action on the control ports 128 to trigger the teaming/failover controller 126 on the computing device 112 to fail over an active network interface 124 (FIG. 2) to one of the standby network interfaces 124.

Once the configuration has been completed (Steps 141, 142), the intelligent failover controller 134 on the network switch 116 monitors the operational status of each of the external links. In particular, at step 143, the intelligent failover controller 134 (FIG. 2) monitors the STP state of each of the external switch ports 130. At step 144, the intelligent failover controller 134 compares the results obtained during the monitoring step (Step 143) with the external failure events identified by the triggers configured at Step 142. If an external failure event has not been identified, the monitoring step (Step 143) is repeated and looped until an external failure event has been identified.

Upon identifying that an external failure event has occurred at Step 144, the intelligent failover controller 134 identifies the related control ports 128 at Step 145. At Step 146, the intelligent failover controller 134 initiates a link drop for each of the control ports 128 identified at Step 145 as being related to the external failure event determined at Step 144. After a link drop has been initiated on the control ports 128, process flow returns to Step 143 continuing to monitor external link states and repeating Step 144 through Step 146, as necessary.

FIG. 3B illustrates a flow diagram of one embodiment of a teaming/failover monitor and control process 150 that is separately running on the computing device 112 (FIG. 2), while the external link monitor and failover control process 140 (FIG. 3A) is running on the network switch 116 (FIG. 2). At Step 152, the teaming/failover controller 126 (FIG. 2) on the computing device 112 (FIG. 2) monitors the status of the internal communication links 123 (FIG. 2). At Step 154, the teaming/failover controller 126 determines from the monitored link status whether any of any of the active internal communication links 123 are have been dropped (i.e., deactivated). If none of the internal communication links 123 have been dropped, flow returns to the monitoring step (Step 152) and the process repeats. However, upon detecting that one of the active internal communication links 123 has been dropped, the teaming/failover controller 126 fails over from the active network interface of the failed internal communication link 123 to one of the other standby network interfaces 124 connected to a different internal communication link 123.

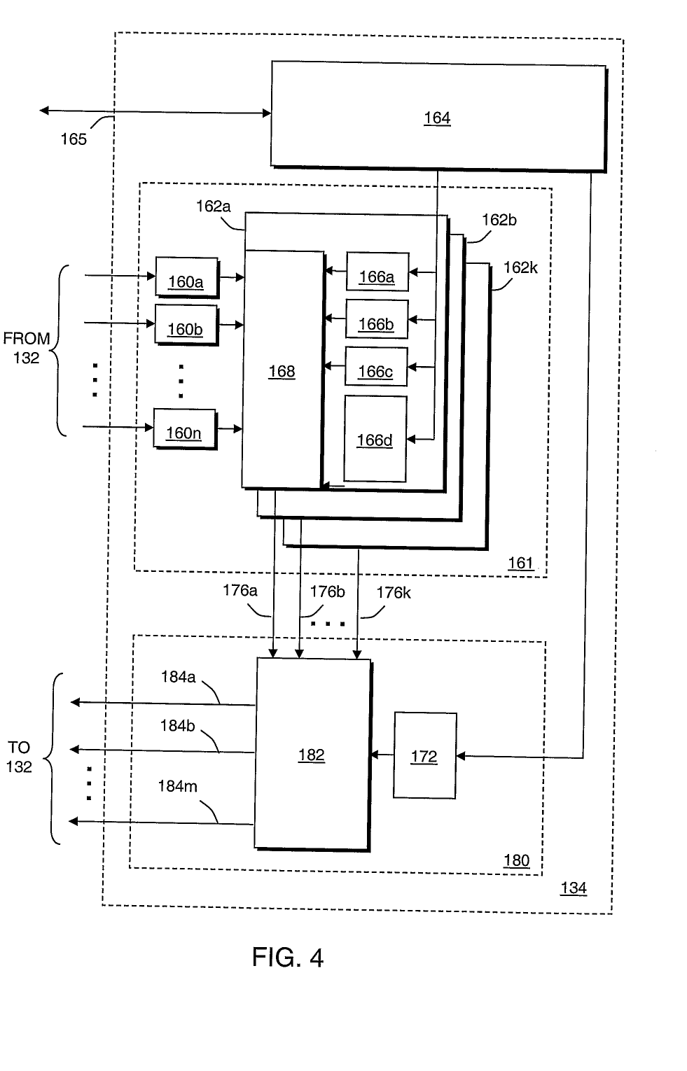

FIG. 4 illustrates a more detailed block diagram of one embodiment of an intelligent failover controller 134 on the network switch 116. The intelligent failover controller 134 includes a monitor 161, a link-drop controller 180, and a configuration controller 164. The configuration controller 164 receives an external input 165, typically during a configuration process, providing configuration information to the monitor 161 and the link-drop controller 180. The monitor 161, in turn, includes a separate STP state monitor 160a, 160b . . . 160n (generally 160) for each of the external ports, and one or more triggers 162a, 162b . . . 162k (generally 162). In some embodiments, each of the trigger 162 includes one or more registers 166a, 166b, 166c, 166d (generally 166) for storing configuration information received from the configuration controller 164, and a logic module 168 in communication with the outputs from the STP state monitors 160 and the one or more registers 166.

The STP state monitors 160 receive information from the switching module 132 (FIG. 2) regarding the STP status of the external switch ports 130 (FIG. 2), one STP state monitor 160 for each external switch port. As described above for an STP-enabled network switch 116 (FIG. 2), the switching module 132 includes a separate STP state machine for each of the external switch ports 130. The monitor 161 includes a separate STP state monitor 160 for each of the external ports, each STP state monitor 160 obtaining an indication as to the STP state of its associated external port 130. Results obtained by the STP state monitors 160 are forwarded in parallel to the one or more triggers 162 to be processed by the triggers 162 together with other information received from the configuration controller 164.

In some embodiments, each of the triggers 162 captures defined external failure events and provide respective trigger output 176a, 176b . . . 176k (generally 176) in response to detecting such an event. Each trigger 162 accesses certain configuration information provided in the registers 166, such as a monitor limit value, on/off status of VLAN monitoring, on/off status of the trigger, and a list of the monitor ports associated with the trigger 162.

The link-drop controller 180 includes a register 172 for storing configuration information. In particular, this register includes a list of the control ports associated with each of the one or more triggers 162. The link-drop controller 180 also includes logic 182 receiving the trigger outputs 176 and comparing them to the configuration information of the register 172. Upon detecting that one or more trigger events have occurred, the logic 182 identifies the related control ports and forwards one or more link drop commands 184a, 184b . . . 184m to the internal switch ports of the switch module 132. In some embodiments, the logic 182 is in communication with the switch module 132, forwarding the one or more link drop commands 184 to the switch module 132. The switch module 132, in turn, drops the internal communication links 123 associated with the identified control ports 128.

At least one application of the intelligent failover process is in a blade server system. In general, a blade server system is a self-contained computer system in which more than one blade server modules are provided within a single chassis to achieve a high-density form factor. Each blade server module is itself a computing device, similar to a typical server but with many of the components removed for space savings, power savings and other considerations. The blade server modules are mounted within an enclosure or chassis that provides services common to the blade server, such as power, cooling, networking, various interconnects and management.

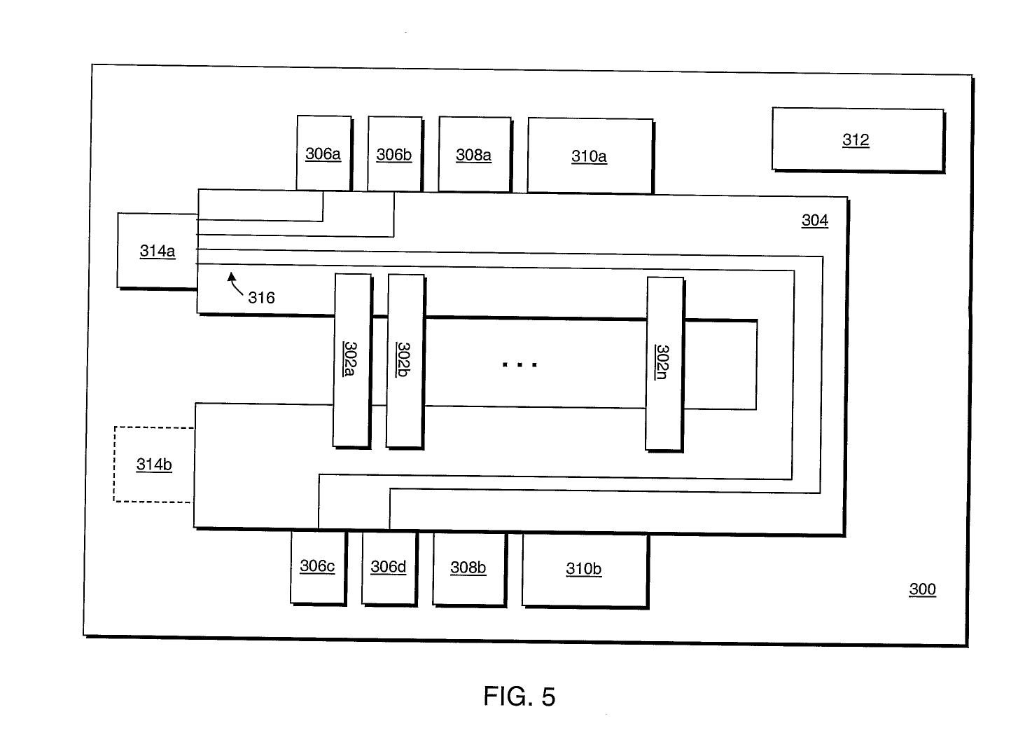

FIG. 5 illustrates an exemplary blade server system including a housing 300 containing multiple blade server modules 302a, 302b . . . 302n (generally 302). The housing 300 includes a backplane or midplane 304 (depending whether it is located at the rear of the chassis or in the middle of the chassis) that includes a printed circuit board having multiple connecters, each adapted to receive a respective one of the multiple blade server modules 302. The housing 300 also includes one or more network switches 306a, 306b, 306d, 306e (generally 306), one or more power supply modules 308a, 308b (generally 308) and one or more cooling/blower units 310a, 310b (generally 310). The switches 306, power supply modules 308, and cooling/blower units 310 are also coupled to the midplane 304, which distributes power and routes communication, command, and control signals therebetween. The housing 300 also includes a front panel/media tray 312 providing input/output and status information.

One example of such a blade server system is the IBM® ESERVER® BLADECENTER®, commercially available through International Business Machines Corporation of Armonk, N.Y., which provides enhanced monitoring capabilities for blade servers, which utilize teaming software to provide high availability and fault tolerance. Each blade server in an IBM® ESERVER® BLADECENTER® chassis can be configured with multiple network interfaces, each of which is connected to a different network switch, such as NORTEL® layer 2/3 copper Gigabit Ethernet switch module, model no. 32R1860 commercially available through Nortel Networks Limited, of Quebec, Canada. The detection of an internal link drop is required to trigger the teaming software on the blade server to switch its active link from one network interface to another.

In some embodiments, the blade server housing or chassis 300 also includes a management module 314a coupled to one or more of the different blade server chassis components 302, 306, 308, 310 through the midplane 304. The management module 314a can be coupled to one or more of the blade server modules 302 and the switches 306 through a system bus. Alternatively or in addition, the management module 314a can be coupled to the switches 306 through a secondary bus, such as a serial inter-integrated circuit (I²C) bus 316. In some embodiments, the blade server chassis 300 includes a second management module 314b connected similar to the first management module 314a, but in a redundant manner.

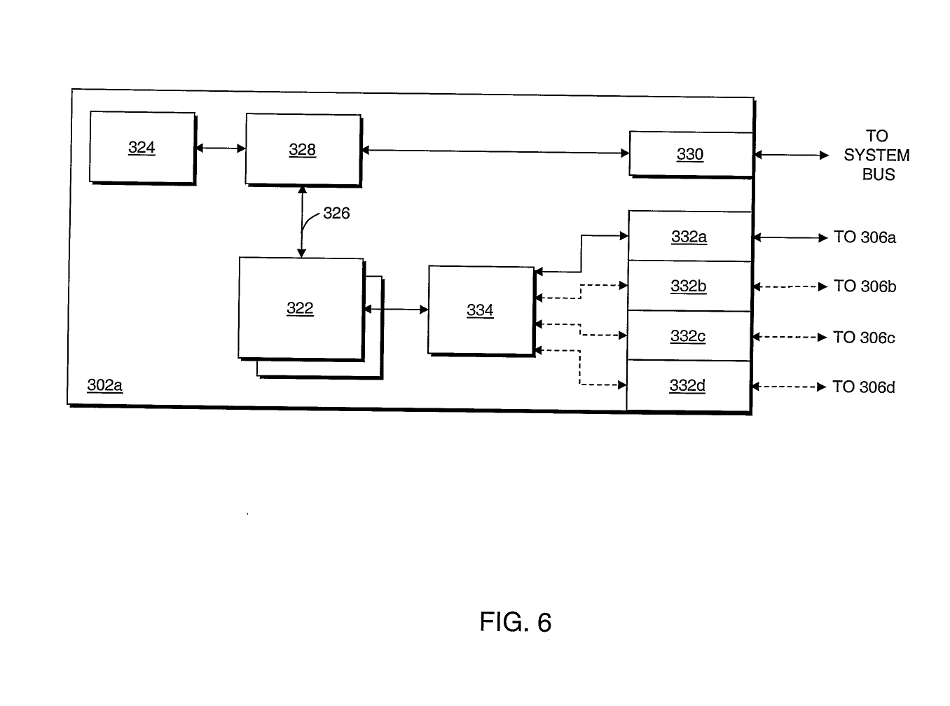

FIG. 6 illustrates a more detailed block diagram of an exemplary blade server module 302 (FIG. 5) including a teaming/failover capability. The blade server module 302 includes one or more onboard processors 322, local memory 324, and a memory and input/output controller 328 coupled to the onboard processors 322 through a local bus 326. Depending upon the particular system bus used within the blade server chassis 300 (FIG. 5), the blade server module 302 also includes a bridge 330 coupled to the memory and input/output controller 328. The bridge 330 enabling the blade server module 302 to communicate with other blade server modules 302 within the same blade server chassis 300, the switch modules 306, and the management module 314.

The blade server module 302 also includes multiple network interfaces 332a, 332b, 332c, 332d (generally 332) each coupled to a respective network switch 306 through an internal communication link (not shown) provided by the midplane 304. A teaming/failover controller 334 is in communication with the processor 322 and each of the network interfaces 332. As shown, one of the network interfaces 332a is active, the remaining network interfaces 332b, 332c, 332d inactive, but ready to become active upon initiation by the teaming/failover controller 334.

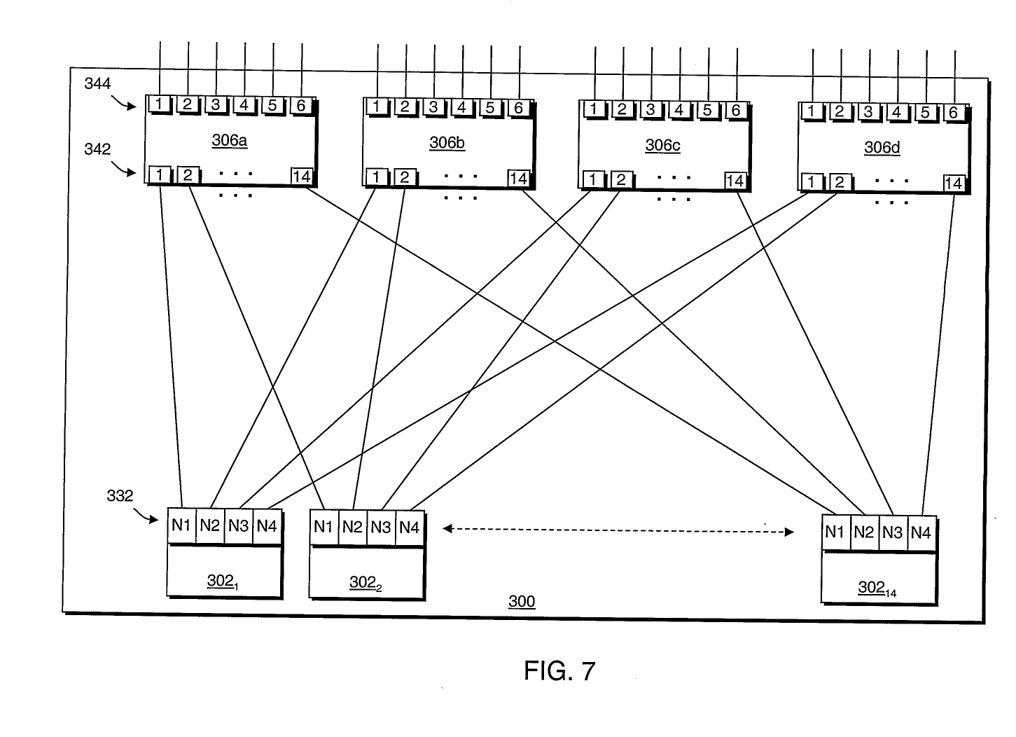

A schematic illustration of the interconnections between the multiple network interfaces 332 of the fourteen blade server module 302₁, 302₂ . . . 302₁₄ to the four network switches 306 of the exemplary blade server system of FIG. 6 is shown in FIG. 7. Each of the blade server modules 302 includes four network interfaces 332 (labeled N1, N2, N3, N4), one for each of the four network switches 306. Each of the network switches 306, in turn, has up to fourteen internal switch ports 342 with one switch port connected to each of the up to fourteen blade server modules 302. As shown, a first network interface N1 of each of the fourteen blade server modules 302 is interconnected to the first network switch 306a. The second network interface N2 of each of the fourteen blade server modules 302 is interconnected to the second network switch 306b and so on. Each of the network switches 306 includes up to six external switch ports 344 that couple to a remote network through external communication links. Thus, each of the switches can selectively interconnect one or more of the blade server modules 302 to a remote network. Illustrative examples based on this exemplary configuration are provided below.

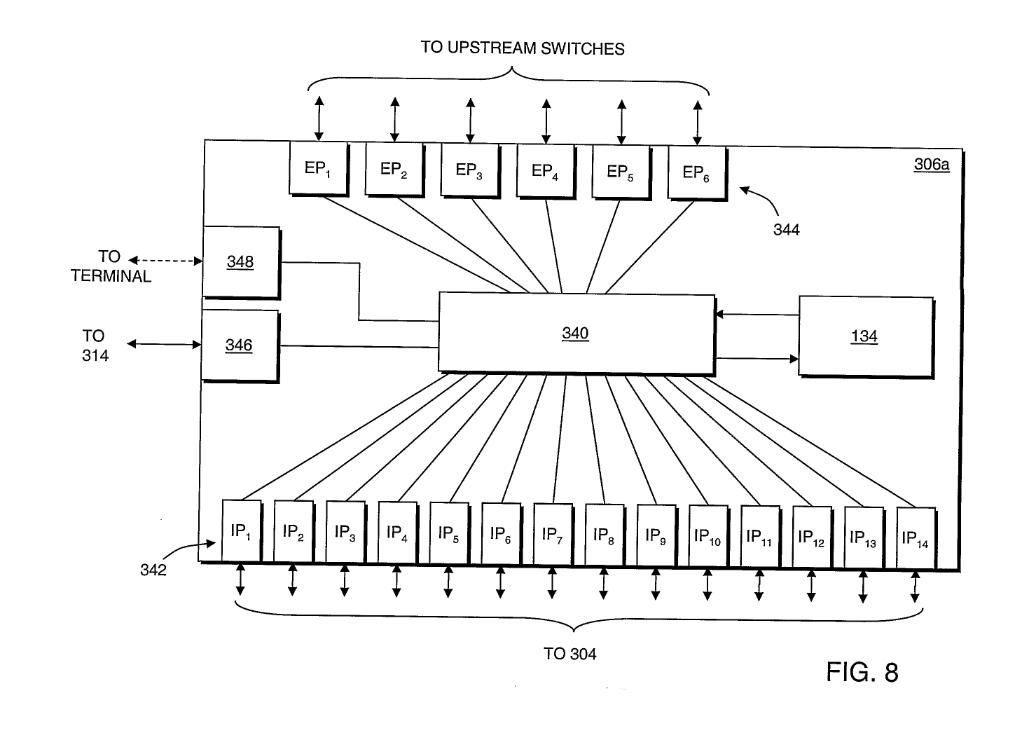

FIG. 8 illustrates a more detailed block diagram of one embodiment of a network switch 306 (FIG. 7). The network switch 306 includes a switching module 340 coupled between the internal switch ports 342 and the external switch ports 344. For a blade server chassis configuration, the internal switch ports 342 are coupled through the midplane 304 (FIG. 5), whereas the external switch ports 344 terminate in respective physical ports on the switch module. For example, the external switch ports can terminate in an RJ-45 copper connection or an optical transceiver, such as a Small Form-factor Pluggable (SFP) compact optical transceiver.

The network switch 306 also includes another internal management switch port 346 that can be connected to a management module 314 (FIG. 5) in a blade server chassis 300 (FIG. 5). The management switch port 346 is connected to the switching module 340 thereby allowing the management module 314 to monitor and control different features of the network switch 306. For example, the network switch 306 can support multiple protocols, such as STP, LACP, VLAN and static trunking. The functionality associated with each of these protocols can be provided within the switching module 340. In some embodiments, configurable parameters of the different protocols and features of the network switch 306 can be accessed and manipulated by the management module 314 through the management port 346.

One or more of the different protocols and features of the network switch 306 can also be accessed by one or more of the blade server modules 302 (FIG. 5) through in-band control. Thus, commands can arrive at the switch directly from the blade server modules 302 through the internal switch ports 342. In some embodiments, the network switch 306 can also support a browser-based interface. Thus, the configurable parameters of the different protocols and features of the network switch 306 can be accessed and manipulated locally or remotely through a browser interface that may be hosted on one of the blade server modules 302 or on a remote server connected also connected to the network 114 (FIG. 2).

In some embodiments, each of the network switches 306 also includes a respective terminal port 348, such as an RS-232 serial communications port. The terminal port 348 is connected to the switching module 340, such that a remote terminal device (i.e., a “dumb” terminal) connected to the terminal port 348 can be used to monitor and control the network switch 306. This method of access is referred to as a command line interface (CLI). Thus, the network switch 306 can provide CLI menu structure to guide an administrator through the process of monitoring and controlling the network switch 306.

The network switch 306 also includes an intelligent failover controller 134 connected to the switching module. The same manner of monitoring and controlling the switching module 340 can be used to monitor and control the intelligent failover controller 134. Access to the intelligent failover controller 134 can be obtained as shown through the switching module 340.

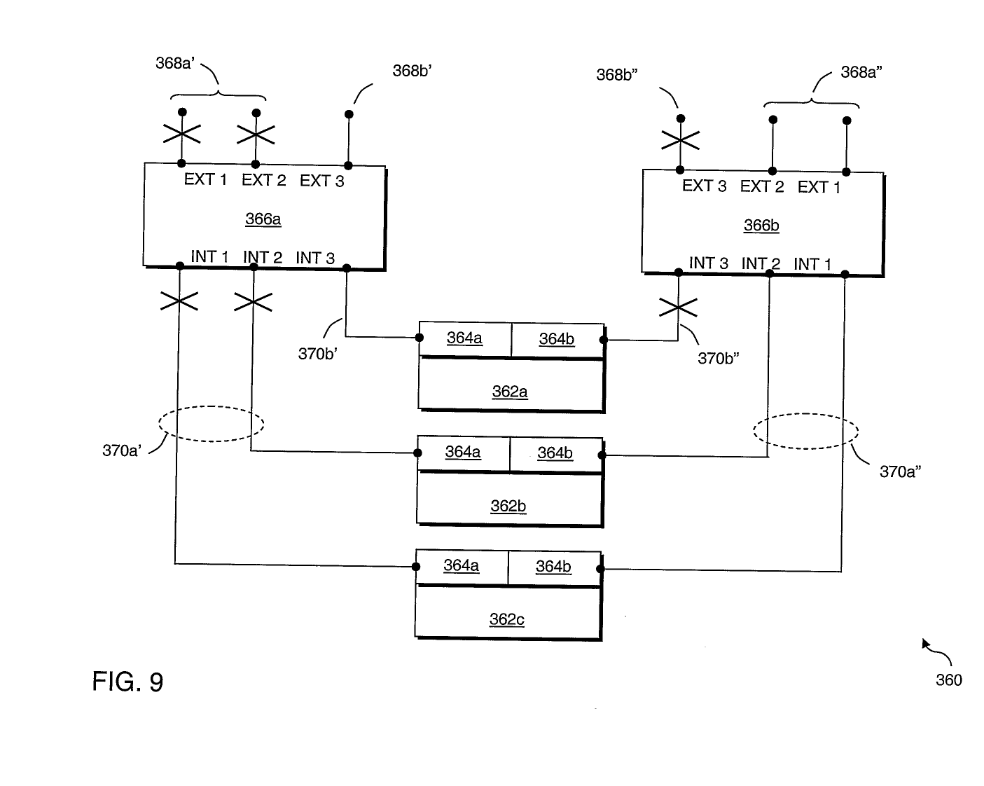

FIG. 9 illustrates a block diagram of another exemplary embodiment of a high-availability, fault-tolerant communications network 360. The network 360 includes three blade server modules 362a, 362b, 362c (generally 362), each including two network interfaces 364a, 364b. The network 360 also includes two switches 366a, 366b, each configured with three internal ports INT1, INT2, INT3 and three external ports EXT1, EXT2, EXT3. Each of the internal ports of the first switch 366a is connected to a first network interface 364a of a respective blade server module 362. Similarly, each of the internal ports of the second switch 366b is connected to a second network interface 364b of a respective blade server module 362, whereby each blade server is simultaneously connected, at least physically, to both of the switches 366a, 366b.

The network 360 is further configured having a first VLAN 370a″ and a second VLAN 370b′. The first VLAN 370a″ is configured to include the first and second internal ports INT1, INT2 and the first and second external ports EXT1, EXT2 of the second switch 366b. The second VLAN 370b′ is configured to include the third internal port INT3 and the third external port EXT3 of the first switch 366a. Thus, the first and second VLANS 370a″, 370b′ reside on different switches. With the redundant configuration shown, a redundant first VLAN 370a′ is configured to include the first and second internal ports INT1, INT2 and the first and second external ports EXT1, EXT2 of the first switch 366a; and a second, redundant VLAN 370b″ is configured to include the third internal port INT3 and the third external port EXT3 of the second switch 366b.

The external ports of the first VLAN 370a″ (EXT1 and EXT2) are grouped together as a first trunk 368a″. The external port of the second VLAN 370b′ (EXT3) is grouped together as a second trunk 368b′. The external ports of the first and second redundant VLANs 370a′, 370b″ are similarly grouped together in first and second trunks 368a′, 368b″. The “Xs” positioned near the ports of the switches 366 indicate that the adjacent port is not active. Switch ports without “Xs” positioned near them are active.

The intelligent failover controller includes an internal teaming engine designed to operate independently on a defined set of monitor and control ports. By removing dependency from the external configuration, the internal teaming engine design allows for greater flexibility to adapt to future modifications and enhancements. All teaming configuration is remapped internally and can be represented as a bitmap of monitor and control ports. The following example illustrates how the teaming configuration can be remapped internally and utilized by the teaming engine.

In the exemplary of FIG. 9, Trunk Group 1 contains external ports EXT1 and EXT2; Trunk Group 2 contains external port EXT3; VLAN1 contains external ports EXT1 and EXT2 and internal ports INT1 and INT2; and VLAN2 contains external port EXT3 and internal port INT3. A first trigger, Trigger 1, contains Static Trunk 1. The monitor ports for Trunk 1 include external ports EXT1 and EXT2 and the control ports include internal ports INT1 and INT2. The monitor ports for Trunk 2 include external port EXT3 and the control port includes internal port INT3. Table I provides a summary of the STP based monitor results for all of the ports.

TABLE I
Port Status

| | SWITCH 1 | SWTICH 2 |
|---|---|---|
| EXT PORTS: | STP State: | STP State: |
| Ext1 | Blocked | Forwarding |
| Ext2 | Blocked | Forwarding |
| Ext3 | Forwarding | Blocked |
| INT PORTS: | Link Status: | Link Status: |
| Int 1 | Down | Up |
| Int 2 | Down | Up |
| Int 3 | Up | Down |

By way of illustrative example, operation of another exemplary system for each of a number of different configuration scenarios is provided below. In particular, the following exemplary scenarios illustrate how the external teaming configuration is remapped internally. In some embodiments, the external teaming configuration is remapped and represented as a bitmap of monitor and control ports for use by the triggers. In general, all of the examples refer to a system similar to that illustrated in FIG. 7, in which multiple switches 306 and up to fourteen blade server modules 302, each having multiple network interfaces 332, one interface 332 for each of the multiple switches 306. The network switch 306 includes at least fourteen internal ports 342, each coupled to a respective one of the blade server modules 302. Through a configuration process, one or more VLANs can be defined in terms of the internal and external ports 342, 344. Alternatively or in addition, one or more of the external links can be configured in a trunking arrangement (static or LACP).

As a first Example, a network system of FIG. 7 is configured with five VLANs and three spanning tree groups (STG). A summary of the VLAN and STG configuration is summarized in Table II. Thus, VLAN 1 includes internal ports 1, 6 and 7; VLAN 2 includes external ports 1, 2 and 3 and internal ports 2, 8, 9 and 10; and so on. A VLAN tagging feature, if available, is disabled for the first four scenarios.

TABLE II
First Exemplary VLAN/STG Configuration

| | | | | |
|---|---|---|---|---|
| VLAN 1: | | int(1, 6, 7) | STG 1: | VLAN(1) |
| VLAN 2: | ext(1, 2, 3) | int(2, 8, 9, 10) | | VLAN(4) |
| VLAN 3: | | int(3, 11) | | VLAN(5) |
| VLAN 4: | ext(4, 5) | int(4, 12) | STG 2: | VLAN(2) |
| VLAN 5: | | int(5, 13, 14) | STG 3: | VLAN(3) |

A first exemplary scenario with the above configuration summarized in Table I provides a single trigger (Trigger 1) and a single trunk (Trunk 1) with VLAN monitor off. Trunk 1 includes external ports Ext1 and Ext2. With the VLAN monitor off any configured VLANs will be ignored by the trigger. Thus, upon detecting an external failure event at one of the switches 306 (FIG. 7), link drops will be issued for all of the internal ports of that switch. As described above, the induced internal link drops will cause teaming/failover action on the interconnected blade server modules 302. Thus, any blade server modules 302 having active links through the effected switch will failover to another switch 306, thereby reestablishing communications through the other switch 306.

A summary of the first exemplary scenario is provided in Table III. The table is split into two segments with a left-hand segment providing a so-called front-end failover configuration. This front-end failover configuration information reflects information entered by a network administrator during configuration of the system. In this scenario, the administrator has identified a single trigger (Trigger 1) for monitoring Trunk 1. The administrator has also identified a limit of 0 for the identified trunk. Thus, an external failure event exists when zero links of Trunk 1 are in an STP forwarding state.

The ports (Ext1 and Ext2) listed in the table result directly from the inclusion of Trunk 1, as this trunk has been pre-configured to include these ports. Although not necessary with VLAN monitor off, the VLAN associated with the ports of Trunk 1 are also identified. This association is summarized in Table II, with ports Ext1 and Ext2 belonging to VLAN2 and VLAN2 belonging to STG2.

The right-hand segment of Table III is referred to as the back-end failover monitor. This segment of the table reflects the monitor ports as those ports necessarily monitored in determining whether an external failure event of Trigger 1 exists. Since Trigger 1 includes only Trunk 1, which includes external ports Ext1 and Ext2, only these external ports need to be monitored. This segment of the table also reflects the associated control port links to be dropped in the event of detecting the related external failure event (i.e., Trigger 1 is “triggered”). Since the VLAN monitor is off, all of the internal ports of the switch detecting the trigger events are failed over.

With the information provided in Table III, the intelligent failover controller 134 (FIG. 4) receives the monitored STP state information for external ports Ext1 and Ext2 and compares the monitored results with the requirements of Trigger 1. With a limit of zero, failover will occur after there are zero monitor links remaining. Thus, if only one of external ports Ext1 or Ext2 is not in the STP forwarding state, an external failure event is not declared and network communications are unaffected. However, when both of the external ports are not in the STP forwarding state, an external failure event is declared (i.e., limit 0) and the intelligent failover controller 134 initiates a link drop action on all of the identified control ports (i.e., ports Int1 through Int14).

TABLE III
Scenario 1: Single Trigger, Single Trunk, VLAN Monitor OFF

| Front-end | | | | | | | Back-end | |
|---|---|---|---|---|---|---|---|---|
| Failover Configuration | | | | | | | Failover Monitor | |
| Trigger | Limit | Auto Monitor | Ports | PVID | VLAN | STG | Monitor: | Control: |
| 1 | 0 | addtrnk 1 | Ext1 | 2 | 2 | 2 | ext(1, 2) | int(1-14) |
| | | | Ext2 | 2 | 2 | 2 | | |

A summary of a second exemplary scenario is provided in Table IV. This scenario is essentially the same front-end failover configuration of the preceding scenario, the only difference being that the limit is now set to 1. Additionally, for this scenario the VLAN monitor feature is ON. With a limit set to 1, a failover on Trigger 1 will occur when there is 1 monitor link remaining. Thus, if either of the external ports (Ext1, Ext2) is not in the STP forwarding state, an external failure event is declared. With VLAN monitor on, the control ports now depend upon those internal switch ports associated with the identified VLANs. Referring to Table II to identify those internal ports associated with VLAN2 yields internal ports int(2, 8, 9, 10). Thus, failover on trigger 1 will bring down control links coupled to internal switch ports int(2, 8, 9, 10).

TABLE IV
Scenario 2: Single Trigger, Single Trunk, VLAN Monitor ON

| Front-end Failover | | | | | | | | |
|---|---|---|---|---|---|---|---|---|
| Configuration | | | | | | | Back-end | |
| | | Auto | | | | | Failover Monitor | |
| Trigger | Limit | Monitor | Ports | PVID | VLAN | STG | Monitor: | Control: |
| 1 | 1 | addtrnk 1 | ext1 | 2 | 2 | 2 | ext(1, 2) | int(2, 8, 9, 10) |
| | | | ext2 | 2 | 2 | 2 | | |

A summary of a third exemplary scenario is provided in Table V. In this scenario, the limit is once again set to 1 for trunk 1, but a second trunk, Trunk 2, is also added to the same trigger. Referring to the trunk configuration, Trunk 2 includes external port Ext3. Referring to Table II, external ports Ext1, Ext2, and Ext3 all belong to VLAN 2. From the front-end failover configuration, the monitor ports of Trigger 1 include ext(1, 2, 3). Referring again to Table II with VLAN monitor ON, the control ports associated with VLAN2 are internal ports int(2, 8, 9, 10). Thus, failover on Trigger 1 will bring down control links coupled to internal switch ports int(2,8,9,10).

A failover on trigger 1 will only occur when there is 1 monitor link remaining. Thus, an external failure event will only occur when only one of the monitor ports remains in the STP forwarding state. Additional restrictions can also be defined and applied during the configuration stage, such that multiple trunks within the same trigger must belong to the same VLAN membership and share the same PVID.

TABLE V
Scenario 3: Single Trigger, Mulit-Trunk, VLAN Monitor ON

| Front-end | | | | | | | | |
|---|---|---|---|---|---|---|---|---|
| Failover Configuration | | | | | | | Back-end | |
| | | Auto | | | | | Failover Monitor | |
| Trigger | Limit | Monitor | Ports | PVID | VLAN | STG | Monitor: | Control: |
| 1 | 1 | addtrnk 1 | Ext1 | 2 | 2 | 2 | ext(1, 2, 3) | int(2, 8, 9, 10) |
| | | | Ext2 | 2 | 2 | 2 | | |
| | | addtrnk 2 | Ext3 | 2 | 2 | 2 | | |

A summary of a fourth exemplary scenario is provided in Table VI. This scenario includes the same configuration for Trigger 1 as identified in Table V, but adds a second trigger, Trigger 2. The second trigger is associated with an LACP trunk identified by an LACP key. For the instant example, the LACP trunk includes external ports Ext4 and Ext5. Inspection of table II identifies that these ports are associated with VLAN 4, which also includes internal ports Int4 and Int12.

Failover on trigger 1 will occur as described in the preceding scenario having the same trigger. Failover on trigger 2, however, will occur when there are no monitor links remaining, since the Trigger 2 limit set to 0 (i.e., none of the monitor ports are in the STP Forwarding state). A Failover on trigger 2 will bring down control links int(4, 12). An additional rule requires that multiple triggers not operate on the same VLAN.

TABLE VI
Scenario 4: Multi-Trigger, Multi-Trunk, LACP Key, VLAN Monitor ON

| Front-end | | | | | | | | |
|---|---|---|---|---|---|---|---|---|
| Failover Configuration | | | | | | | Back-end | |
| | | Auto | | | | | Failover Monitor | |
| Trigger | Limit | Monitor | Ports | PVID | VLAN | STG | Monitor: | Control: |
| 1 | 1 | addtrnk 1 | Ext1 | 2 | 2 | 2 | ext(1, 2, 3) | int(2, 8, 9, 10) |
| | | | Ext2 | 2 | 2 | 2 | | |
| | | addtrnk 2 | Ext3 | 2 | 2 | 2 | | |
| 2 | 0 | addkey 1 | Ext4 | 4 | 4 | 1 | ext(4, 5) | int(4, 12) |
| | | | Ext5 | 4 | 4 | 1 | | |

In the following exemplary scenarios, the VLAN TAGGING feature has been enabled, with an associated configuration summarized below in Table VII. External ports Ext1, Ext2 and Ext3 belong to the same static trunks as described in the above scenarios. In addition, external ports Ext4 and Ext5 are configured to belong to an LACP trunk being identified by LACP key 1.

TABLE VII
Second Exemplary VLAN/STG Configuration

| | | | | |
|---|---|---|---|---|
| VLAN 1: | ext(1, 2, 3) | int(1, 6, 7) | STG 1: | VLAN(1) |
| VLAN 2: | ext(1, 2, 3) | int(2, 8, 9, 10) | | VLAN(4) |
| VLAN 3: | ext(1, 2, 3) | int(3, 11) | | VLAN(5) |
| VLAN 4: | ext(4, 5) | int(4, 12) | STG 2: | VLAN(2) |
| VLAN 5: | ext(4, 5) | int(5, 13, 14) | STG 3: | VLAN(3) |

A summary of a fifth exemplary scenario is provided in Table VIII. Triggers, limits, and trunks being monitored are identical to the scenario summarized in Table VI; however, the VLANs and STGs differ resulting from VLAN tagging being ON. An inspection of each of the external ports associated with the identified trunks and comparison to Table VII identifies all of the VLANS associated with each external port. The monitor ports remain the same as in the preceding scenario; however, the control ports differ according to the identified VLANs.

Thus, a failover on Trigger 1 will occur when there is 1 monitor link remaining associated with static Trunks 1 and 2. A failover on Trigger 1 will bring down control links int(1-3, and 6-11). A failover on Trigger 2 will occur when there are 0 monitor links remaining associated with LACP key 1. Failover on trigger 2 will bring down control links int(4,5,12,13,14). Note that multiple trunks within the same trigger must belong to the same VLAN memberships and share the same PVID. Also note that multiple triggers are not allowed to operate on the same VLANs. Also note that each Monitor port link STP state will be checked only on the default PVID (even if the trigger may belong to multiple VLANs on different STP groups).

TABLE VIII
Scenario 5:
Multi Multi-Trigger, Mulit-Trunk, LACP Key, VLAN Monitor ON

| Front-end | | | | | | | | |
|---|---|---|---|---|---|---|---|---|
| Failover Configuration | | | | | | | Back-end | |
| | | Auto | | | | | Failover Monitor | |
| Trigger | Limit | Monitor | Ports | PVID | VLAN | STG | Monitor: | Control: |
| 1 | 1 | addtrnk 1 | ext1 | 2 | 1, 2, 3 | 1, 2, 3 | ext(1, 2, 3) | int(1, 2, 3, 6, 7, 8, 9, |
| | | | ext2 | 2 | 1, 2, 3 | 1, 2, 3 | | 10, 11) |
| | | addtrnk 2 | ext3 | 2 | 1, 2, 3 | 1, 2, 3 | | |
| 2 | 0 | addkey 1 | ext4 | 4 | 4, 5 | 1 | ext(4, 5) | int(4, 5, 12, 13, 14) |
| | | | ext5 | 4 | 4, 5 | 1 | | |

The last exemplary scenario demonstrates an invalid configuration having overlapping control links between triggers. It will assume that VLAN tagging is enabled with a VLAN/STG configuration identified in Table IX.

TABLE IX
Third Exemplary VLAN/STG Configuration

| | | | | |
|---|---|---|---|---|
| VLAN 1: | ext(1, 2, 3, 4, 5) | Int(1, 6, 7) | STG 1: | VLAN(1) |
| VLAN 2: | ext(1, 2, 3) | Int(2, 8, 9, 10) | | VLAN(4) |
| VLAN 3: | ext(1, 2, 3) | Int(3, 11) | | VLAN(5) |
| VLAN 4: | ext(4, 5) | Int(4, 12) | STG 2: | VLAN(2) |
| VLAN 5: | ext(4, 5) | Int(5, 13, 14) | STG 3: | VLAN(3) |

A summary of a fifth exemplary scenario is provided in Table X. The front-end failover configuration is similar to that of the preceding scenario, but for the identified VLANs. The VLAN identification differs based on the new VLAN/STG configuration of Table IX. In particular, each of the triggers (Trigger 1 and 2) includes an overlapping VLAN, namely VLAN1. Examination of the resulting control ports reveals that there is overlap. Internal ports Int1, Int6, and Int7 appear as control ports for each of the triggers. This is unacceptable, as a failure event of either of the triggers would result in a partial failover of some of the control ports of the other trigger.

In some embodiments, the configuration controller 164 (FIG. 4) includes error checking to identify conflicts in the configuration and flag them to the network administrator during the configuration phase. For example, the configuration controller 164 can determine any occurrence of overlapping control ports based on a selected configuration. Further, the configuration controller 164 can identify the configuration of the conflicting triggers to inform the network administrator of the location of the error thereby allowing for the error to be remedied during the configuration process.

TABLE X
Scenario 6:
Invalid Multi-Trigger, Mulit-Trunk, LACP Key, VLAN Monitor ON

| Front-end | | | | | | | | |
|---|---|---|---|---|---|---|---|---|
| Failover Configuration | | | | | | | Back-end | |
| | | Auto | | | | | Failover Monitor | |
| Trigger | Limit | Monitor | Ports | PVID | VLAN | STG | Monitor: | Control: |
| 1 | 1 | addtrnk 1 | ext1 | 2 | 1, 2, 3 | 1, 2, 3 | ext(1, 2, 3) | int(1, 2, 3, 6, 7, 8, |
| | | | ext2 | 2 | 1, 2, 3 | 1, 2, 3 | | 9, 10, 11) |
| | | addtrnk 2 | ext3 | 2 | 1, 2, 3 | 1, 2, 3 | | |
| 2 | 0 | addkey 1 | ext4 | 4 | 1, 4, 5 | 1 | ext(4, 5) | int(1, 4, 5, 6, 7, 12, |
| | | | ext5 | 4 | 1, 4, 5 | 1 | | 13, 14) |

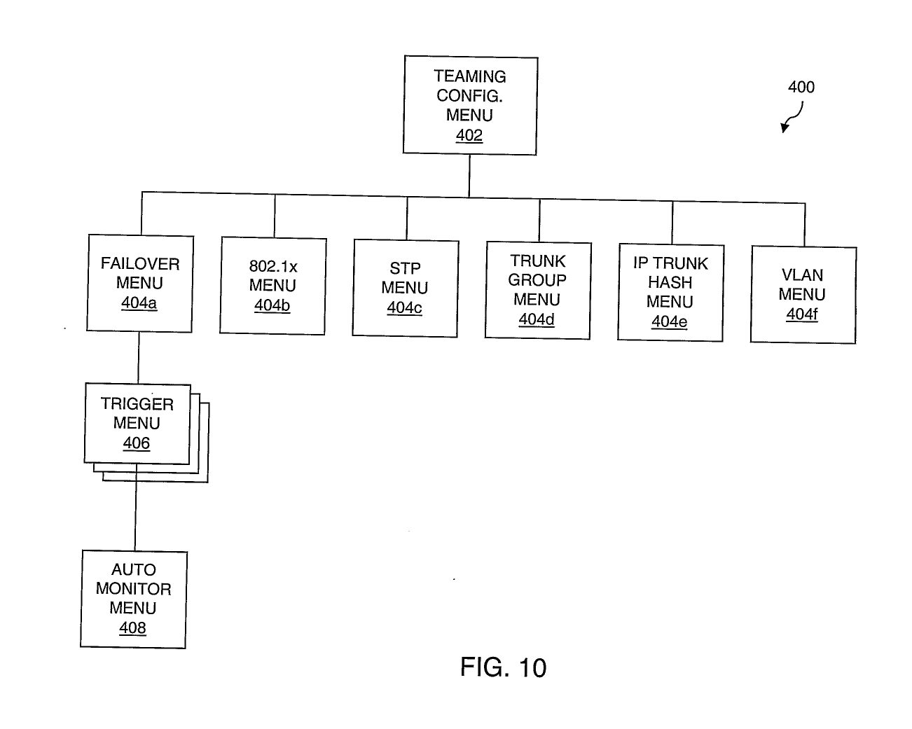

FIG. 10 illustrates a schematic representation of an exemplary menu structure 400 used to configure the high-availability, fault-tolerant communications network. These menus can be provided over the command line interface to guide a network administrator through configuring the resources from a local terminal device. Alternatively or in addition, similar menus can be provided over a browser-based interface allowing a network administrator to configure the resources either locally or remotely from a networked system.

A first-tier menu 402 facilitates access to the managed resources. The first-tier menu 402 provides access to one or more second-tier menus 404a-404f (generally 404). The first-tier menu 402 optionally provides a feature to allow a network administrator to quickly view the configuration of the controlled resources. The number and type of second-tier menus 404 depend upon the available features, but at a minimum includes a failover menu 404a for configuring the failover features, such as definition of the triggers identifying external failure events. Other second-tier menus include an IEEE 802.1x menu 404b for managing LACP features; a STP menu 404c for managing STP features; a trunk group menu 404d for managing static trunks; an IP trunk has menu 404e for further managing the use of trunks; and a VLAN menu 404f for managing VLANs.

Each of the second-tier menus 404 can include one or more additional sub menus, depending upon the particular application. The failover menu 404a includes multiple third-tier menus 406, one for each trigger. In some embodiments, up to eight triggers are provided requiring eight separate trigger menus. Even lower-tier menus, such as an auto monitor menu 408 can be provided, and are accessible from the trigger menus 406.

In operation, a network administrator navigates the menu structure during a configuration process to properly configure the networked resources. The configuration process can be repeated as necessary. Configuration information provided during this process is preserved and can be stored in one or more locations. The information provided by the exemplary menu structure applies to operation of each of the network switches 116 (FIG. 2). In some embodiments, each of the switches 116 includes a local memory to store the configuration information. Alternatively or in addition, a common memory is provided, accessible by all of the network switches 116. For example, the management module 314 (FIG. 5) can include a local memory storing the configuration information. This information can be accessed by the switches 306 over a system bus or the I2C bus, which can also store the configuration information locally between configuration events.

While the invention has been shown and described with reference to specific embodiments, it should be understood by those skilled in the art that various changes in form and detail may be made therein without departing from the spirit and scope of the invention.

What is claimed is:

1. A method for maintaining network connectivity in a computing device coupled to a network through at least one spanning-tree-protocol enabled switch, the computing device including a plurality of network interfaces adapted in a failover configuration, one of the network interfaces being active and in communication with an internal switch port, the active network interface in switchable communication with the network through at least one external switch port, the method comprising:
monitoring a spanning-tree-protocol state of the at least one external switch port;
identifying an external failure event based on the monitored spanning-tree-protocol state;
deactivating an internal link coupled between the active network interface and the internal switch port in response to the identified external failure event; and
failing over to another one of the plurality of network interfaces in response to the deactivated internal link.

2. The method of claim 1, wherein identifying an external failure comprises a monitored spanning-tree-state other than a forwarding state.

3. The method of claim 1, further comprising identifying virtual local area network (VLAN) groups, wherein identifying an external failure is based on the monitored spanning-tree-protocol state of the at least one external switch port belonging to the identified VLAN, and deactivating in response to the identified external failure event, one or more of the internal links coupled between the plurality of network interfaces and the internal switch ports, the internal links also belonging to the identified VLAN.

4. The method of claim 3, wherein the VLAN includes static trunk groups.

5. The method of claim 3, wherein the VLAN includes link aggregation control protocol trunk groups.

6. The method of claim 1, further comprising reestablishing an active network interface using the failed over network interface.

7. The method of claim 1, further comprising defining the external failure event.

8. The method of claim 7, wherein defining the external failure event comprises specifying a minimum number of external switch ports required to be in a spanning-tree-protocol forwarding state, an failure event being when less than the specified minimum number of external switch ports are in the spanning-tree-protocol forwarding state.

9. The method of claim 1, further comprising defining a set of monitor and control ports associated with an external failure event, spanning-tree-protocol states being monitored for the defined monitor ports and all of the defined control ports being deactivated upon identifying the external failure event.

10. A network-enabled computer system for maintaining high availability network connectivity between the computer system and a network comprising:
a computing device including a plurality of network interfaces adapted in a failover configuration, each network interface coupled to one side of a respective internal communication link, one of the network interfaces being active;
a spanning-tree-protocol enabled switch having an internal port coupled to another side of the respective internal communication link in switchable communication with least one external port coupled to the network through an external communication link; and
an intelligent failover controller including:
a fault monitor in communication with the spanning-tree-protocol enabled switch, monitoring a spanning-tree-protocol state at the at least one external port; and
a link-drop controller in communication with the fault monitor, selectively initiating a link drop of the internal communication link in response to the monitored spanning-tree-protocol state, the active network interface failing over to another one of the plurality of network interfaces in response to the link drop.

11. The network-enabled computer system of claim 10, wherein the computing device comprises a blade server system having a plurality of blade server modules, each including a respective plurality of network interfaces adapted in a failover configuration, each network interface coupled to one side of a respective internal communication link, one of the network interfaces being active for each of the plurality of blade server modules.

12. The network-enabled computer system of claim 10, wherein the intelligent failover controller selectively initiates a link drop of the internal communication link in response to the monitored spanning-tree-protocol state being any state other than a spanning tree forwarding state.

13. The network-enabled computer system of claim 10, wherein one or more of the at least one external ports are bundled together to form a single logical channel according to a link aggregation control protocol.

14. The network-enabled computer system of claim 10, wherein one or more of the at least one external ports are bundled together to form a static trunk.

15. The network-enabled computer system of claim 10, wherein the failover controller comprises a plurality of triggers each respectively defining at least one external event measured by the monitored spanning-tree-protocol states initiates the link drop of the internal communication link.

16. The network-enabled computer system of claim 15, wherein the trigger is configurable.

17. The network-enabled computer system of claim 15, wherein each of the plurality of triggers distinguishes among a plurality of configurable virtual local area network (VLAN) groups, each of the plurality of triggers operating on a respective VLAN group.

18. The network-enabled computer system of claim 10, further comprising:
a configuration controller receiving administrator-provided configuration input; and
a configuration engine converting the administrator-provided configuration input into a machine-readable configuration map.

19. A network-enabled computer system having a computing device coupled to a network through at least one spanning-tree-protocol enabled switch, the computing device including a plurality of network interfaces adapted in a failover configuration, one of the network interfaces being active and in communication with an internal switch port, the active network interface in switchable communication with the network through at least one external switch port, comprising
means for monitoring a spanning-tree-protocol state of the at least one external switch port;
means for identifying an external failure event based on the monitored spanning-tree-protocol state;
means for deactivating an internal link coupled between the active network interface and the internal switch port in response to the identified external failure event; and
means for failing over to another one of the plurality of network interfaces in response to the deactivated internal link.
